(19) United States
(12) Patent Application Publication
(10) Pub. No.: US 2012/0253901 A1
(43) Pub. Date: Oct. 4, 2012

(54) DYNAMIC OFFER PAIRING AND DISTRIBUTION SYSTEMS AND METHODS

(75) Inventors: Shane Montgomery, McKinney, TX (US); Norman C. Leong, Schaumburg, IL (US)

(73) Assignee: Event Bonus LLC

(21) Appl. No.: 13/437,924

(22) Filed: Apr. 2, 2012

Related U.S. Application Data
(60) Provisional application No. 61/471,099, filed on Apr. 1, 2011.

(51) Int. Cl. G06Q 30/02

(52) U.S. Cl. 705/14.5

(57) ABSTRACT

An offer pairing and distribution system includes: an electronic processing and storage device associated with an offer pairing engine and an offer distributor, wherein the offer pairing engine receives input profiling events, vendors, venues, and distributors to create one or more offers to be distributed via the offer distributor to one or more qualified users who request distribution of the one or more offers when located within a defined location and epoch.

### CROSS-REFERENCE TO RELATED APPLICATIONS

This application claims the benefit of U.S. Provisional Application No. 61/471,099, filed on Apr. 1, 2011, the entirety of which is incorporated herein by reference.

### BACKGROUND OF THE INVENTION

The present subject matter relates generally to an electronic system and methods for dynamically pairing and distributing offers. More specifically, the present invention relates to systems and methods for dynamically pairing users of mobile electronic devices with rewards for interacting with selected events, venues, vendors, and distributors.

One challenge or goal for marketers is in rewarding users for interacting with desired events, venues, vendors, and/or distributors. Creating and distributing offers (i.e., rewards) to users to encourage specific interactions can be exceptionally beneficial to businesses that benefit from the interaction. The quality of the offers provided affects the effectiveness of the offer's ability to induce the desired interactivity.

As use of mobile devices continues to increase, particularly mobile devices that enable geo-location services, either through systems such as GPS location services or by voluntary check-ins, such as through various social media platforms, there are increased opportunities for using the location of the user to further target rewards to be offered to users.

Accordingly, a need exists for systems and methods for dynamically pairing users of mobile electronic devices with rewards for interacting with selected events, venues, vendors, and distributors, as described and claimed herein.

### BRIEF SUMMARY OF THE INVENTION

The present disclosure provides various systems and methods for dynamically pairing users of mobile electronic devices with rewards for interacting with selected events, venues, vendors, and distributors. As used throughout this written description, the term offer applies to any offer provided to an end user, but is most specifically envisioned as a reward to a user for a specific interaction with a combination of any combination of one or more events, venues, vendors, and/or distributors.

In one example, the systems and methods provided herein may be used to pair offers with prospects that are present at specified events/locations. For example, an offer may be provided such that Vendor A provides an offer for a discount on Yankee apparel for prospects that confirm their attendance at Yankee Stadium when the New York Yankees play the Boston Red Sox on Aug. 22, 2012 from 1:20 PM to approximately 4:30 PM. A tiered offer may be created such that the first designated number of prospects that request distribution of the offer will be provided a tier 1 offer (highest value) and that later requests will be paired with lesser value, lower tier, offers.

In one example, an offer pairing and distribution system includes: an electronic processing and storage device associated with an offer pairing engine and an offer distributor, wherein the offer pairing engine receives input profiling events, vendors, venues, and distributors to create one or more offers to be distributed via the offer distributor to one or more qualified users who request distribution of the one or more offers when located within a defined location and epoch.

In one example, a method of pairing and distributing offers includes the steps of: generating profiles for events, venues, vendors, and distributors; pairing a combination of events, venues, vendors, and distributors to create an offer using the profiles generated for events, venues, vendors, and distributors; exploiting an offer wherein one or more paired offers are publicized to qualified and unqualified prospects; qualified distribution of the paired offers to qualified prospects; receiving an acceptance of an offer by a qualified prospect; enhancing the offer, which may include the additional steps of offer expiration and post-expiration offer enhancement, whereby the accepted offers may be enhanced by adapting the value or duration of the offer; receiving a request to redeem an offer, wherein a qualified prospect redeems the offer; and rewarding a qualified prospect for participation. The method may further include the steps of media data collection and media scoring to generate a media score that is used to assign a value to the events, venues, vendors, and distributors for which media data is collected.

Numerous examples and embodiments of the systems and method provided herein are detailed in the detailed description below.

An advantage of the systems and methods provided herein is the ability to drive traffic to specified location(s) during a specific date/time range.

Another advantage is the systems and methods do not exclude users from viewing potential offers, but do include/exclude users from receiving rewards based on user location or location at some point during qualifying epoch.

Another advantage is that by qualifying users to an offer based on location of a user device, there is no need to sign in or piggy-back on a social media network.

A further advantage is that tiered offers may be provided in relative proportions rather than in absolute quantity by waiting to the closing of a qualified epoch, determining the number of qualified offers and then distributing tiered offers in relative proportions (e.g., 15% of offers from tier 1, 30% of offers from tier 2, and 55% of offers from tier 3).

Yet another advantage is the system and methods may be implemented in disaster relief areas such that the location of the individuals may be used to qualify them for relief. For example, prospect's within a given location range qualify themselves in order to be able to post needs. Needs may include: evacuation, food, shelter, medicine, transportation, support, etc.). The system quantifies, categorizes, and displays needs. The system further pairs vendors that can best meet needs (including capacity, current inventory, time to delivery, etc.) with the users. The system appeals to ROW organizations, countries, and individuals to meet needs with most direct path.

Another advantage is that the systems and methods may be used to provide short term, specific, offers to specified user range to provide improved inventory management, capacity management, or exposure management for business.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic representation of an offer pairing and distribution system.

FIG. 2 is flow chart illustrating one example of a method of offer pairing and distribution.

FIG. 3 is a schematic representation of an offer pairing engine.

FIG. 4 is a schematic representation of an offer stratification module.

FIG. 5 is a schematic representation of a user/offer qualification system.

FIG. 6 is a schematic representation of an offer distribution system.

FIG. 7 is a schematic representation of an offer enhancement system.

FIG. 8 is a schematic representation of a programmed media offer pairing system.

### DETAILED DESCRIPTION OF THE INVENTION

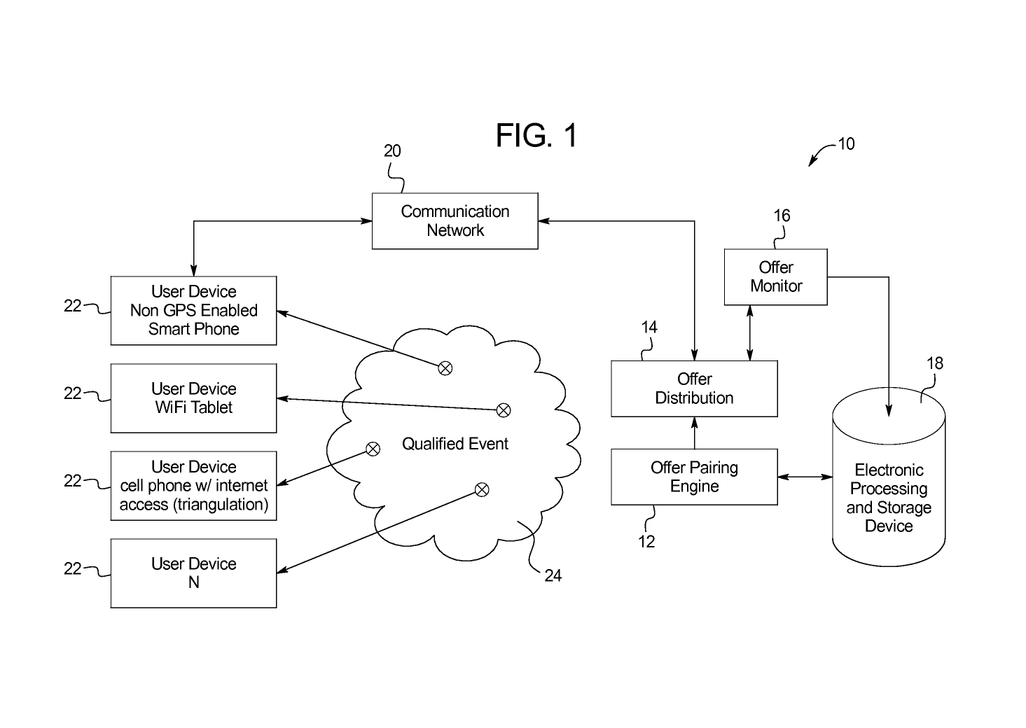

FIG. 1 illustrates an example of an offer pairing and distribution system 10. As shown in FIG. 1, the offer pairing and distribution system 10 includes: an offer pairing engine 12; an offer distributor 14; an offer monitor 16; an electronic processing and storage device 18; a communication network 20; one or more mobile electronic devices 22 (user devices 22); and a qualified event 24. The example of the offer pairing and distribution system 10 shown in FIG. 1 is merely one example of such a system 10. It is contemplated that the various individual elements of the system 10 may be incorporated into or provided as a greater or lesser number of elements. For example, elements like the offer pairing engine 12, the offer distributor 14, and the offer monitor 16 may all be incorporated into the electronic processing and storage device 18, but are referred to herein as separate elements for purposes of clarity.

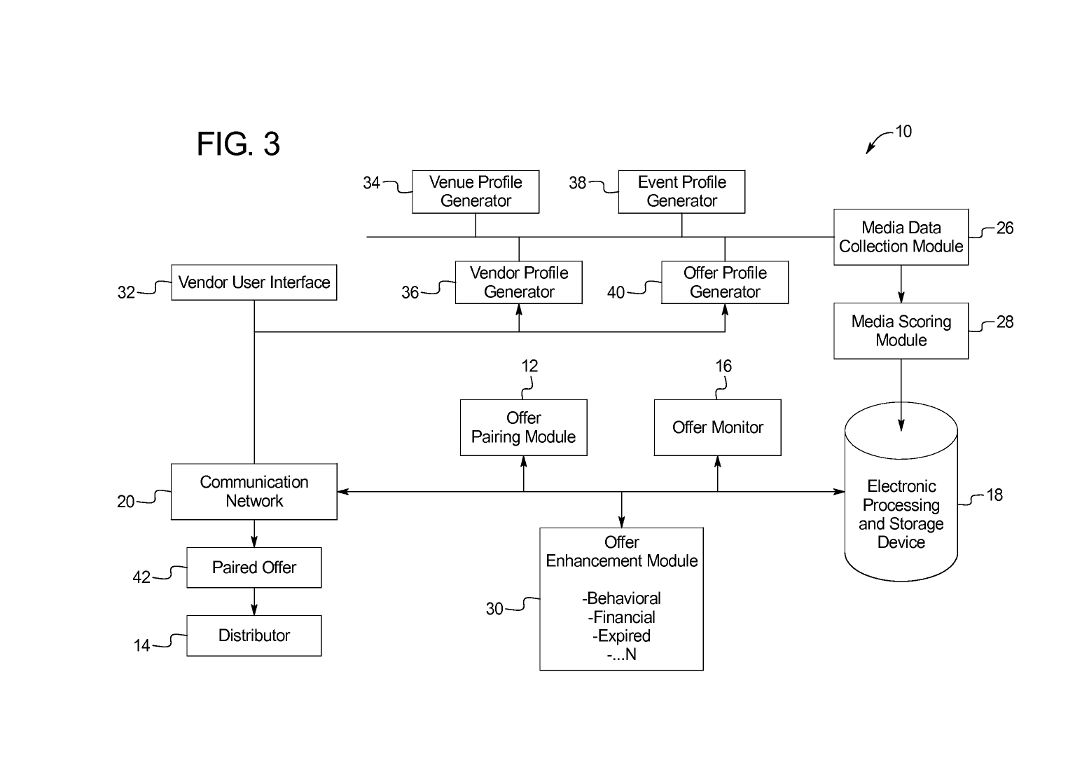

The offer pairing and distribution system 10 dynamically pairs users of mobile electronic devices 22 with rewards for interacting with selected events, venues, vendors, and distributors. The offer pairing and distribution system 10 is well adapted to drive traffic to specified location(s) during specific date/time ranges (e.g., one or more qualified events 24). For example, the offer pairing and distribution system 10 does not exclude users from viewing potential offers, but does include/exclude users from receiving offers based on user location or location at some point during a qualified event 24. The components of the offer pairing and distribution system 10 are described in further detail herein with respect to FIGS. 3-8.

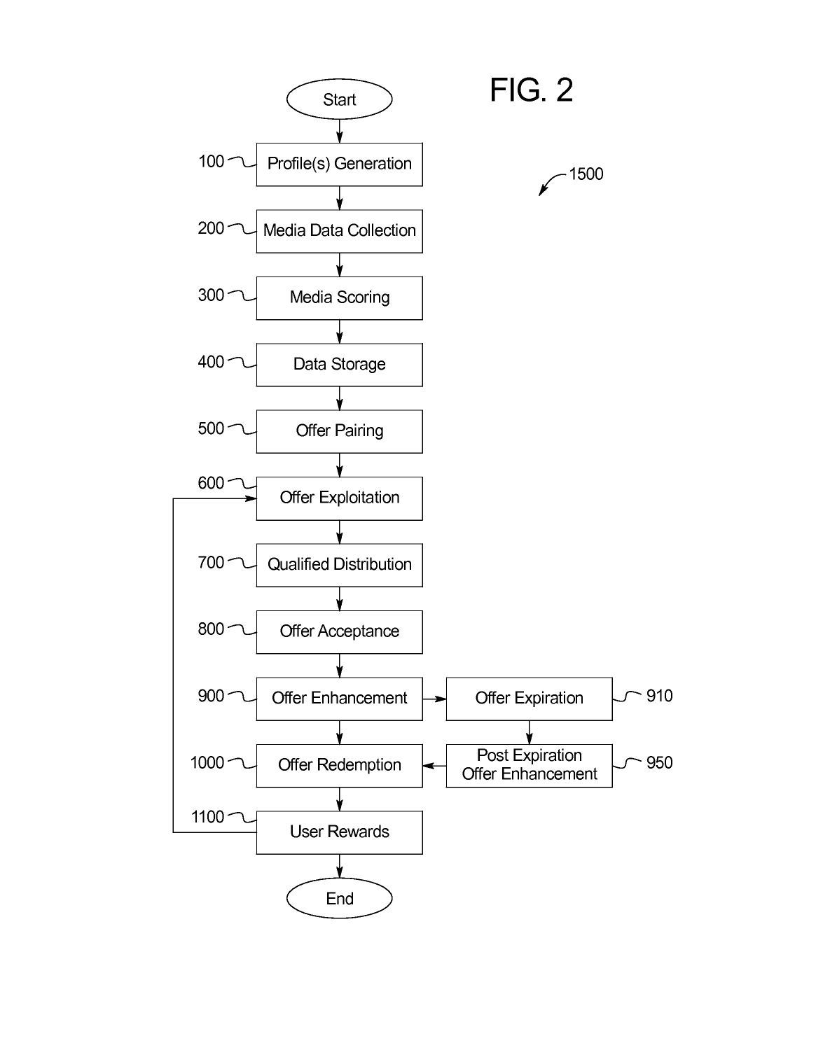

Turning now to FIG. 2, an example of a method of offer pairing and distribution 1500 (method 1500). As shown in FIG. 2, the method 1500 includes a first step of generating profiles 100 (step 100); a second step of media data collection 200 (step 200); a third step of media scoring 300 (step 300); a fourth step of storing data 400 (step 400); a fifth step of offer pairing 500 (step 500); a sixth step of offer exploitation 600 (step 600); a seventh step of qualified distribution 700 (step 700); an eighth step of offer acceptance 800 (step 800); a ninth step of offer enhancement 900 (step 900), which may include the additional steps of offer expiration 910 (step 910) and post-expiration offer enhancement 950 (step 950); a tenth step of offer redemption 1000 (step 1000); and an eleventh step of rewarding a user 1100 (step 1100).

The first steps of the method 1500 form a “pairing phase,” within which offers to be used in a “distribution phase” are generated. Through the pairing phase, one or more electronic processing and storage devices 18 perform iterative calculations and processes to determine optimal performance by analyzing data and relationships between vendor, event, venue (physical and/or electronic locations), distributor input, historical data, etc. The output can be a combination of text, number, graphs, plots, diagrams, and/or models to form suggestions, statistics, predictions, extrapolations on how to achieve desired offer output, distribution, and market absorption of distributed offer(s). In the pairing phase, attributes of distributor(s), vendor(s), event(s), venue(s), and/or programmed media are profiled, stored, categorized, and tagged (or any combination thereof). An algorithmic scoring system/method suggests, illustrates, and/or determines prospective optimized pairings for success of vendor(s) offer(s), event(s), and venue(s) or any combination. The pairing phase uses various attributes, tags, popularity scores, categories, etc. to predict potential outcomes of offer(s) made by vendors and/or distributors. Attribute data may include, but is not limited to, strategic, media, and/or popularity score analysis of offer(s). The scoring may be based, for example, on data related to revenue, profitability, discounts, inventory, infrastructure capacity, expenses, etc., predicted or historical data related to event(s), predicted or historical data defining event(s) participants, predicted or historical event(s) attendance data, historical or predicted venue(s) exposure capacity. Through the pairing phase, the offer pairing and distribution system 10 recalculates prediction(s) when attributes, popularity score, or historical results are affected by refreshed or updated inputs.

For example, in the example of the method 1500 shown in FIG. 2, the first step of generating profiles 100 includes creating profiles to which various attributes will be associated for any number of distributor(s), vendor(s), event(s), venue(s), and/or programmed media. For example, a venue profile may include venue location data, venue capacity data, data related to the types of events hosted at the venue, a venue calendar of events, etc. In another example, a vendor profile may include various data related to the vendor's goods and services, vendor's pricing data, vendor's target customer demographic data, etc. The profile and associated data information is stored in the electronic processing and storage device 18. It is expected that one having ordinary skill in the art will understand all of the various profile data that may be relevant and/or desired based on the additional disclosures provided herein.

The second step of media data collection 200 may include collecting various data relating to media coverage/exposure/chatter regarding any of the profiled entities. For example, step 200 may include measuring the attention a given event generates through media, the number of Tweets, Likes, articles printed, Internet searches, etc. The third step of media scoring 300 may include assigning weighted scoring values to the media data. The higher the media attention, the greater the score, the more valuable the event (or other profiled element). The fourth step of storing data 400 may include storing the profiles, attributes, and scores within the electronic processing and storage device 18. Steps 100, 200, 300, and 400 may be performed on an ongoing basis such that the various profiles, data, and scores are updated when new data is generated and/or collected.

Through the fifth step of offer pairing 500, distributors, vendors, events, venues, and programmed media are paired to create offers to be distributed to users. Offer pairing may be performed in any of a number of ways. An example is provided to illustrate one manner in which offer pairing 500 may be performed.

In the example provided, the step of offer pairing 500 includes first evaluating one or more vendors and/or distributors for which offers are to be paired. In evaluating the vendors and/or distributors, the offer pairing and distribution system 10 evaluates one or more product(s), promotion(s), offer(s), or service(s) to use for the offer, the evaluated information being drawn from the profiles stored in the electronic processing and storage device 18 or drawn from other sources in real-time. The offer pairing and distribution system 10 further evaluates one or more discounts, pricing tiers, promotions, membership offers, tickets, coupons, etc. for the offer. In addition, the offer pairing and distribution system 10 evaluates one or more epochs (i.e., specified periods of time) for which the offer will apply, for use of the offer, within which the offer will be promoted, within which the service will be available, within which the product will be available, within which a discount or coupon applies, etc. An epoch is defined by a start time and an end time, whether defined directly or defined by providing either a start time or an end time and duration. Additional attributes or terms may be evaluated, such as, whether the offer will be transferable, the quantity of offers allowed per user, any specific applications or uses of the goods or services for which the offer applies, any range of cancellation or void policies, any range of customer reward policies, etc.

The step of offer pairing 500 further includes evaluating events to which the offers will be paired. For example, the event may be: Internet content, including videos, advertisements, articles, blog posts, etc.; television content, including shows, sports, reality programming, advertisements, etc.; radio content; public gatherings, such as, protests, shows, beaches, concerts, races, etc.; private gatherings, such as, book clubs, birthday parties, professional meetings or conferences, charity events, etc. The events may be further defined by times and dates. The events are stored in the electronic processing and storage devices 18 to be evaluated and selected by the offer pairing and distribution system 10.

Additionally, the step of offer pairing 500 may include evaluating one or more venues to which the offers will be paired. The venues are selected based on their appropriateness for communicating the offers to users. Venues may be physical or electronic “locations.” To be available to be selected to be paired with offers, the GPS location points of physical locations are stored in the electronic processing and storage devices 18. The location points may include (x,y), (x,y,z), (x,y,z,t), etc. wherein x=longitude, y=latitude, z=elevation, and t=time, or epoch. The location data may further include, or alternatively be based on, “tags” used to summarize, describe, and define the location, e.g., enclosed, air-conditioned, carpeted, grass, stadium, parking, fitness, health, social, etc. The tags may be provided by users, pulled from public information, or otherwise collected and used. Venues are not only physical locations, they may be electronic locations, such as, URLs, portions of web pages, etc. A venue may be a combination of user location online (e.g., visiting a URL) plus the user's physical location. For example, two users may access a website from separate locations, a first user located in Dallas and a second user located in Chicago. A defined venue may include the combination of accessing the web page while being located in Dallas, but not include accessing the web page while being located in Chicago. Further, in some embodiments, it is envisioned that a venue may be a programmed media event, for example, a television show or other programmed media and, again, may include the location from which a prospect is viewing or interacting with the programmed media.

The step of offer pairing 500 may also include evaluating one or more distributor terms and conditions to apply to the offer. For example, the electronic processing and storage devices 18 may store various distributor policies, including refund policies, fraud policies, distribution policies, promotion customer reward policies, fee and/or pricing policies, etc. These policies may be used to evaluate a distributor to associate with a given offer.

The step of offer pairing 500 may include evaluating a prospect (i.e., individuals exposed to offers) quantity. For example, the evaluated prospect quantity may be a maximum number of prospects (i.e., a capped number), a target number of prospects (i.e., uncapped target), or a maximum or target number of offers accepted by prospects. The number of prospects may or may not be the actual number of offers made to prospects, rather it is an analytical and/or projection tool to help determine the capability of the offer to reach desired objectives (e.g., profits, exposure, acceptance, transactions, notoriety, market saturation, etc.). A vendor, distributor, or any other party may determine the prospect quantity or an optimized quantity may be provided or suggested by the offer pairing and distribution system 10. For example, the offer pairing and distribution system 10 may calculate the potential of event(s), venue(s), and epoch(s), or combination of any, to reach a desired prospect quantity.

In one example, the electronic processing and storage device 18 may use an iterative calculation process along with a prospect quantity as an input to determine performance output between vendor and/or distributor for attracting prospects to offer(s). Prospect quantity can also be an output of the electronic processing and storage device 18 using an iterative calculation process and historical/statistical/extrapolated data to predict optimal performance output. Any one or combination of variable input(s) may be used to select or calculate optimized prospect quantity including: venue capacity; event attendance/participation (historical or projected); epoch; popularity score; and or other factors that may affect attendance (e.g., weather, politics, communication capability, etc.).

Alternatively, the prospect quantity may be limited by the vendor and/or distributor by: limiting the total prospect quantity; limiting the prospect quantity per event(s); limiting the prospects per venue(s); defining the prospect quantity as unlimited; etc.

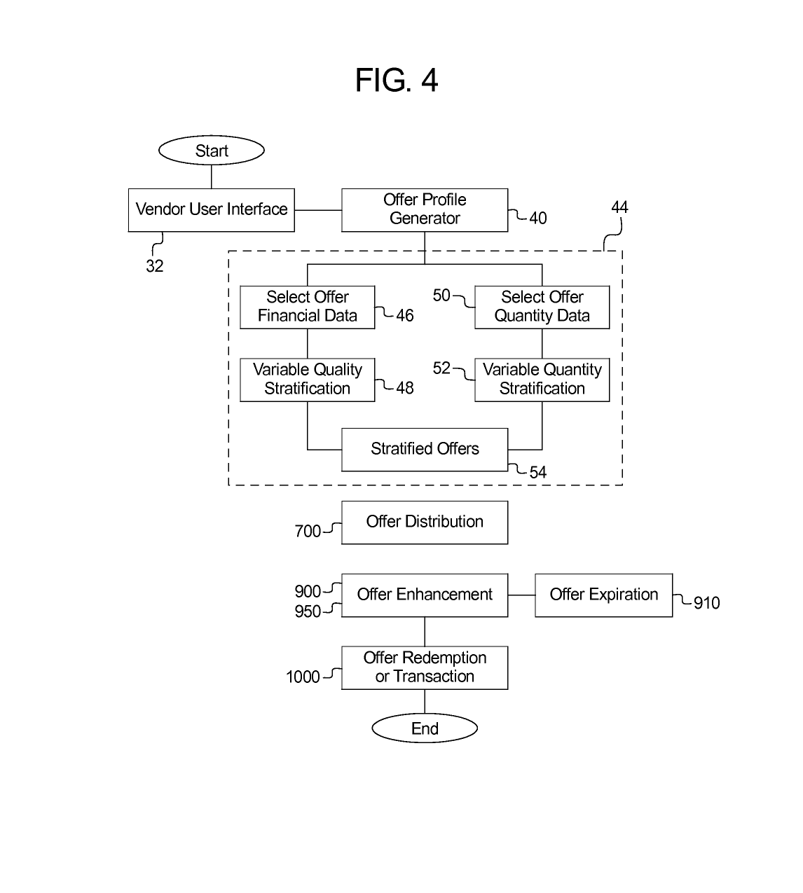

In evaluating various combinations of the distributors, vendors, events, venues, the various combinations may be scored and compared to determine optimized or otherwise beneficial combinations. Such combinations may be selected automatically by the offer pairing and distribution system 10 or may be selected by users of the offer pairing and distribution system 10 based on output provided by the offer pairing and distribution system 10, e.g., combinations of text, number, graphs, plots, diagrams, and/or models to form suggestions, statistics, predictions, extrapolations on how to achieve desired offer output, distribution, and market absorption of distributed offer(s). Further examples related to offer selection are provided below with respect to FIG. 4. The offers may be additionally stratified as described further herein.

Turning back to FIG. 2, the next step in the method 1500 is the step of offer exploitation 600. Step 600 generally includes any and all efforts to make use of the offers created or suggested by the offer pairing and distribution system 10 by getting the offer in front of prospects through any means available including, social, print, radio, and electronic media, etc. For example, offers may be communicated to prospects through a dedicated mobile application, website, or subscription service. In another example, the one or more offers may be communicated through social media channels, direct marketing channels, etc. As shown in FIG. 2, step 600 may occur following the step of offer pairing 500 and it may occur again after the step of rewarding a user 1100. In instances in which offer step 600 occurs after step 1100, it is expected that the rewarded user may participate in the exploitation of the offer by communicating the rewarded activity to other potential prospects, again through any means available, including direct communication, communication through social media, etc.

In some examples, step 600 includes automatic exploitation of the offers. For example, the electronic processing and storage device 18 may use one or more pre-defined templates to automatically generate and publish marketing material with social media attachments. The exploitation of offers promotes participants to attend events, the events expose the offers to the attendees, and the qualification system (described further herein) lets prospects know if they are qualified, how to qualify, where to qualify, etc. for the communicated offers.

The next step shown in the method 1500 illustrated in FIG. 2 is the step of qualified distribution 700. Step 700 includes the process used to qualify prospects to receive offers based on location, time, electronic pathway to offer, prospect actions, or any combination of these characteristics. If a prospect qualifies for an offer, then, with respect to that offer, the prospect is “qualified to receive,” and the qualification attributes are recorded and stored in the electronic processing and storage device 18. Step 700 further includes the process for communicating the offer to the qualified prospect. For example, when the electronic processing and storage device 18 is made aware of a prospect's desire to receive an offer, and the prospect meets the minimum offer requirements, the electronic processing and storage device 18 assigns, and then distributes, the next available qualified offer to the prospect. In a preferred example, prospect qualification and offer distribution (step 700) operate using the FIFO (first in first out) method, though it is understood that any method of organization/prioritization may be employed.

In a preferred embodiment, the qualified distribution 700 process uses, at least in part, contemporaneous location-based information to qualify a prospect for an offer. Accordingly, the electronic processing and storage device 18 may verify the current physical location of a prospect through the user device 22 using application software uploaded to the user device 22 or any other location verification service including, but not exclusively, GPS data, IP address, digital television signal locater, cellular triangulation, satellite optical, location verification service, NFC, RFID, barcode, photo, Bluetooth, 802.11, elevation data, etc. If the prospect's current physical location is within the qualified location range then the prospect may be qualified, if current physical location is not within the qualified location range then the prospect may not be qualified.

For purposes of this disclosure, it is intended that the term location mean any of a number of locations, including and combination of: a physical location (described by any combination of x, y, and z-latitude, longitude, and elevation); a range from a defined point; a polygon of location ranges; any one or combination of the following: an address, metes and bounds, Universal Transverse Mercator (UTM), county, city, county, state, zip, block, area of elevation, political district/area, ward, or radius around a GPS point, or polygon around a GPS point; a web address; a predetermined array of locations, etc.

If the prospect does not qualify based on not being located within a qualified location, the offer pairing and distribution system 10 may notify the prospect of the disqualification and instruct the prospect to go to a qualifying location if the prospect wishes to qualify for the offer.

In addition to the physical location attributes, the qualified distribution 700 process may include qualifying the prospect based on one or more time limitations. For example, the “location” may further require the prospect to be within a given location or range of locations after a start time and before end time, or otherwise within a defined epoch. When a prospect is in the location but before the epoch or after the epoch, the offer pairing and distribution system 10 may notify the prospect to wait in the location until the start of the epoch or that the qualified time period has ended, respectively.

Other qualification criteria may be required. For example, a prospect may be required to submit information to receive an offer (e.g., a coupon, a discount, a promotion, special pricing, a service offer, etc.). In some examples, the prospect may be required to provide their name, an email address or other electronic personal identifier (e.g., social network name or login), gender, age category or range, profession, etc. Of course, there are nearly limitless combinations of qualifications that may be used in the offer pairing and distribution system 10 as will be recognized by those skilled in the art based on the disclosure provided herein.

The step of qualified distribution 700 further includes any offer classification process that may occur. Offer classification may be performed by an electronic calculation system that determines and constructs offers based on rules from profile information (vendor profile data, offer profile data, etc.). For example, the electronic processing and storage device 18 may take all vendor, event, venue, distributor rules/restrictions, along with the prospect quantity and any offer distribution bands or tiers, and use pre-defined or user-specified templates to generate an offer template for each tier of offers. An offer template from each tier may then be submitted to the electronic processing and storage device 18 along with the prospect quantity and offer distribution bands. The electronic processing and storage device 18 may then mass produce the total number of offers per distribution band and assign each tiered offer a unique identifier (e.g., hashkey, barcode, etc). Each prospect may then be classified or qualified into one or more of the tiers. Such qualification may be based on first-come, first-serve, based on last in first out, based on an pre assigned numerical order, based on random distribution methods, etc. Of course, it is contemplated that some offers will be single tier structures in which every prospect is qualified for the same offer.

The step of qualified distribution 700 further includes the offer invitation process. When a prospect qualifies for an offer, the prospect receives an electronic message inviting the prospect to an offer display interface through the user device 22. In one example, upon being aware of the prospect's request to receive the offer, along with qualifying information, the requests are queued up using the FIFO method. In sequential order, each request is assigned the next offer in the existing tiered offer band. If offers have been depleted in the current band, the electronic processing and storage device 18 moves to the next band. Once assigned in the offer pairing and distribution system 10, the offer pairing and distribution system 10 will tag the prospect's identifying information with the offer and send the respective offer to the prospect electronically in the form of a Internet link or other via another preferred delivery method (e.g., PDF, html+css email, sound, RFID service, coupon code, barcode, physical mail, hand delivered, etc.). The offer may connect the prospect to the electronic processing and storage device 18, where upon verification of the qualified identify, the prospect will get the reward that was assigned to the prospect. Further, the offer may be held by the offer pairing and distribution system 10 until redemption, until expiration, or may be held by the offer pairing and distribution system 10 as dormant or used.

If the reward is a single tier offer classification, then the initial offer is provided to prospect. If the reward is a multi-tier offer classification, then rules determine the offer to be provided to the prospect. The tiered offer system will be described in further detail herein.

Returning to FIG. 2, following the step of qualified distribution 700, is the step of offer acceptance 800. In this step the prospect, through the user device 22 accepts the offer provided. Such offer acceptance may occur in any manner in which the user communicates to the electronic processing and storage device 18 that the user has claimed or accepted the offer. For example, the user device 22 may be adapted to run a specific mobile application through which the user claims the offer. Alternatively, the offer may be claimed through access to a designated website or social media platform.

Next is the step of offer enhancement 900. In this step, the offer pairing and distribution system 10 or the user may be given the opportunity to improve the offer made to a specific prospect or group of prospects. For example, upon verification of the prospect's identify and qualification for the offer, the prospect may be provided one or more offers. The prospect may be provided with options to upgrade the offer based on rules set forth by the vendor, distributor, event, venue, etc. In a tiered offer structure, the prospect may be able to traverse up the distribution band, whether in a single band or across multiple bounds. Should a prospect choose to enhance the offer, the prospect must satisfy the rules of the offer enhancement. Once the requirements have been satisfied, the offer pairing and distribution system 10 will terminate the existing offer and create a new, unique offer for the prospect based on the enhancement.

Examples of offer enhancement may include: paying a fee to increase the value of the offer ($10 coupon will become a $20 coupon); paying a fee to increase the duration of an offer (coupon originally set to expire on March 31, will now expire on July 31); provide information to increase the value or duration of the offer (opt in to a mailing list to improve the offer); promote or “exploit” the offer in order to increase the value or duration of the offer (re-Tweet the offer to increase its value); etc.

The enhanced offer is referred to as the final offer. It will be recognized that in certain situations, the next step in the process will be to return to step 800, in which the prospect may accept the final offer. In other instances, the prospect will continue with the unenhanced offer. In any case, again, there are any number of ways in which the user may accept the an offer or final offer including: printing an offer (e.g., coupon); receipt of and electronic offer; receipt of an electronic price discount code; selecting an “I accept” key or other acceptance indication tool; stating “I accept” and sending electronic voice recording; answering a voice conversation in the affirmative; or otherwise consenting to receive offer whether verbally, electronically, in writing, by physical receipt of item, by physical gesture, etc.

After the step of offer enhancement 900, the offer may either be redeemed in step 1000 or may expire in step 910. For example, the offer may expire if it is valid for a limited epoch whose time has passed.

As further shown in FIG. 2, the method 1500 may include the step of post-expiration offer enhancement 950. Again, like in step 900 discussed above, any number of enhancements may be provided to improve the offer to the prospect. For example, the offer may be combined with additional unique, related or unrelated services or products, or adjusted prices for the services or products, in order to further enhance the offer. The offer pairing and distribution system 10 may adapted to track the prospects' usage of the distributed offers such that the offer pairing and distribution system 10 may analyze the prospects' behavior and create further incentives to attain the desired action by the prospect. For example, based on whether or not the qualified prospect to whom an offer has been distributed may be monitored to determine whether the offer has been accessed, printed/not printed, redeemed/not redeemed or whether the prospect's interests, behavior, or other demographic information may make them a target for additional marketing or follow-up offers. Prospects may be grouped into classes or buckets such that they may be managed as a group or they may be dealt with on the individual level.

Examples of post-offer enhancements that may be appropriate if the offer is not consummated or otherwise redeemed before an expiration period include: extension of the expiration date (since offers may have substantial value, the extension of the expiration date may also have substantial value); extension of the expiration date in exchange for reduction in offer value; further improvement of offer value to induce an additional payment from recipient to a distributor or a vendor; further improvement of the offer value to induce a user transaction through a connection to other promotions; additional offers based on behavioral patterns (which may further need to be qualified by location, time, or other qualifying factor(s)); an improvement of the offer value in order to induce an offered transaction with a vendor or distributor; etc. Of course, numerous other post-offer enhancements may be employed. In each case, the redemption of any of post-offer enhancements may occur in step 1000.

The final step of the method shown in FIG. 2 is the step of rewarding a user 1100. Users may be rewarded for their activities and interactions with the offer pairing and distribution system 10. For example, the offer pairing and distribution system 10 may reward users with “event points” based on: the quantity of occurrences with qualified events; the quantity of completed electronic transactions with vendor(s); the quantity of redistributed offers transacted; etc. In addition, users may be rewarded for referrals and for participating in the step of offer exploitation 600.

The example of the method 1500 provided in FIG. 2 is merely one example of a method 1500 according to the present invention. It is contemplated that there are numerous embodiments of the method 1500 that will be understood by those skilled in the art based on the disclosure provided herein.

Turning now to FIG. 3, an example of the offer pairing and distribution system 10 through which an offer pairing engine 12 is shown and will be described in further detail. In addition to the offer pairing engine 12, FIG. 3 shows the offer distributor 14, the offer monitor 16, the electronic processing and storage device 18, and the communication network 20. The offer pairing and distribution system 10 further includes: a media data collection module 26; a media scoring module 28; an offer enhancement module 30; a vendor user interface 32; a venue profile generator 34; a vendor profile generator 36; an event profile generator 38; an offer profile generator 40; and a paired offer 42.

The example of the offer pairing and distribution system 10 shown in FIG. 3 includes additional tools to assist in carrying out the method 1500 described above with respect to FIG. 2. For example, the media data collection module 26 and the media scoring module 28 may be used to assist in performing step 200 and step 300, respectively. The offer enhancement module 30 may be provided to assist in performing step 900 and step 950. In addition, a vendor user interface 32 is provided through which a vendor may manage a venue profile generator 34, a vendor profile generator 36, an event profile generator 38, and an offer profile generator 40 to assist in performing step 100, the step of profile generation 100. Through the venue profile generator 34, the vendor profile generator 36, the event profile generator 38, and the offer profile generator 40, one or more users can assist in developing the profiles used for the venues, vendors, events, and offers in the offer pairing and distribution system 10. It is understood that any greater or lesser number of tools may be provided to assist in performing step 100. The operation of these tools generally includes: providing tools for a user to input information related to the profiles and storing the information in the electronic processing and storage device 18 or other elements related thereto. An example of an event profile generator 38 is described below to give a more detailed example of one such tool. It is understood that based on the detailed example provided with respect to the event profile generator 38 those skilled in the art will understand the operation of the additional tools shown in FIG. 3.

In the example of the event profile generator 38 shown in FIG. 3, the event profile generator 38 collects information related to an event and then counts, identifies the quality, and scores each of the following data sets to create an “exploitation score.” The exploitation score plus any of the event's external attributes and finite attributes all become factors in pairing offers with events. The pairing may happen dynamically so that the best possible outcome can be provided to the distributor's clients. The objective is for well-targeted offers to be available and selected by the well-suited customers for the vendors to become successful with growing their business(s).

For example, examples of finite limitations for an event may include: capacity (minimum, maximum, predicted); epoch(s) (start time/date to end time/date); historical attendance (0 to N, or unknown); proximal population density score (1=good to 10=bad—this defines how much population is in the area to support the event attendance); transportation score (1=bad to 10=good—this ranks the role transportation plays in facilitating the events attendance); etc.

The event's external attributes may include: external factors (may be dynamic algorithm for each component or manually rated); weather prediction (1=bad to 10=good); political (1=bad to 10=good); popularity score (1=bad to 10=good—popularity score may be a combination of factors such as a team's record, a band's popularity, a speaker's popularity, a show's past attendance in other locations, etc., which will all feed into an algorithm to predict the popularity, thus effect an event's overall success, popularity, social media attention, etc.).

To further illustrate the capabilities of the event profile generator 38 it is helpful to describe the features and functions of the media data collection module 26. The media data collection module 26 uses electronic media collection mechanisms, such as spiders, counters, and scraping techniques to gather information. Collected information is stored in the electronic processing and storage device 18. Information is then sent to the media scoring module 28, which applies scores to the information based on algorithmic methods. The media data collection may be input electronically through applications or may be collected and input manually. Similarly, a system of electronic monitors may be used to gather, update, and collect quantitative or qualitative information related to events, programmed media, vendors, offers, venues, or any sub-component, and be stored and collected by the electronic processing and storage device 18.

The media scoring module 28 scores the collected media to create the event exploitation score. For example, the media scoring module 28 may collect and score data for each of the following categories: new media (e.g., client applications or apps, blogs or blog mentions, websites or website links, deal engines listings); traditional media (e.g., news print (count newspaper articles); magazines (count magazine articles); billboards (count billboards articles); kiosk/in building advertising/foot traffic (count kiosks articles); radio (count radio mentions); television (count television mentions)); search engine media (e.g., Google links, rank, paid advertising (count links and score links for quality); Yahoo! links, rank, paid advertising (count links and score links for quality); Bing links, rank, paid advertising (count links and score links for quality); Alexa score); and social media (e.g., Facebook, including likes, friends, events posted (count likes, count “friends of,” count posted events on topic and score links for quality); Twitter, including tweets, retweats, popularity listings (count tweets, count retweets, count links, count popularity listings and score for quality or viral nature)). The data may then be scored as normalized, weighted scores, for each category of data input, such as rankings from 1-10, wherein 1=bad and 10=good. These scores are then used to create the exploitation score for the event. Similarly, data may be collected, scored, and used to create an exploitation score for each vendor, venue, offer, etc. The exploitation scores are then used to appropriately pair the offers with the events, venues, vendors, and distributors.

FIG. 4 illustrates an offer stratification module 44 accessed through a vendor user interface 32. As shown, a user may engage an offer profile generator 40 through the vendor user interface 32. The offer profile generator 40 may enable the user to: select offer financial data 46, including variable quality stratification 48, and select offer quantity data 50, including variable quantity stratification 52, to create stratified offers 54. The stratified offers 54 may then be used in the method 1500 in step 700 (qualified distribution), step 900 (offer enhancement), including step 910 (offer expiration) and step 950 (post-expiration offer enhancement), and step 1000 (offer redemption).

An example of the operation of an offer profile generator 40 is provided to further demonstrate the use of the offer pairing and distribution system 10. In the example shown in FIG. 4, offers are profiled with an offer profile generator 40 accessed and controlled through a vendor user interface 32. In the example shown, either a distributor or vendor may complete the offer profile generation. The offer attributes may include, but are not limited to: quantity; price discount; percent discount; terms; memberships; exclusivity; service; and other offer attributes. Offer profile data may be stored in the electronic processing and storage device 18, which uses an iterative calculation process, along with discount or price tier, and quantity of recipients per discount, or price tier, to create a flat or structured distribution band(s), as shown by the stratified offers 54. The electronic processing and storage device 18 may create unique hash-keys for every offer in every tier. Offers are time/date stamped, sorted, and categorized serially to the recipients using a first entry in first offer out (FIFO) system. In one example, tiers may be provided based on magnitude of discounts, or price tiers, as an absolute value or as a percentage discount. There may be any number of tiers from 1 to near infinity. For example, there may be a five-tiered group of stratified offers provided such that: within tier 1, 1% or 10 recipients receive tier 1 discount or price; within tier 2, 4% or 40 recipients receive tier 2 discount or price; within tier 3, 15% or 150 recipients receive tier 3 discount or price; within tier 4, 35% or 350 recipients receive tier 4 discount or price; and within tier 5, 45% or 450 recipients receive tier 5 discount or price.

As shown in FIG. 4, the electronic processing and storage device 18, or the offer profile generator 40, may arrive at the stratified offers 54 by selecting offer financial data 46, which leads to variable quality stratification 48, and selecting offer quantity data, which leads to variable quantity stratification 52. Of course, numerous models for stratifying offers may be used in the offer pairing and distribution system 10, of which the example shown in FIG. 4 is just one.

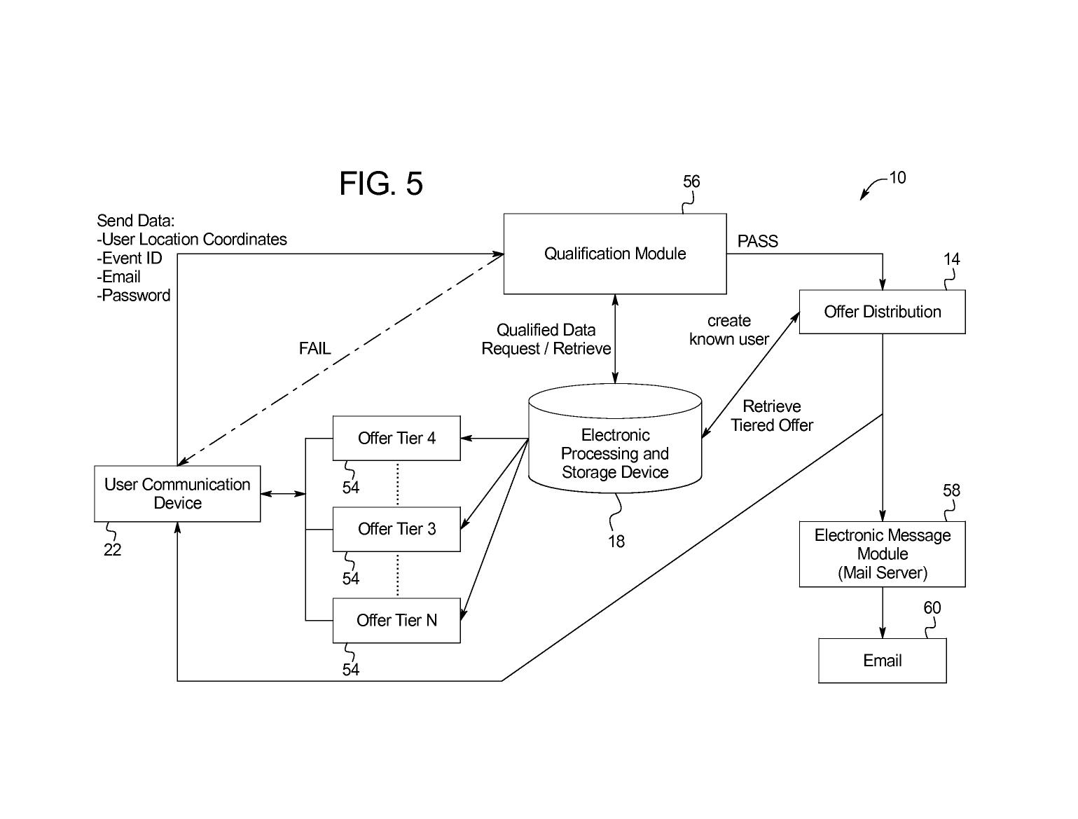

FIG. 5 illustrates a user/offer qualification module 56 incorporated into an example of the offer pairing and distribution system 10. In the example shown in FIG. 5, in addition to the user/offer qualification module 56, the offer pairing and distribution system 10 includes: an offer distributor 14; an electronic processing and storage device 18; one or more user devices 22; one or more stratified offers 54; an electronic message module 56; and an email 60.

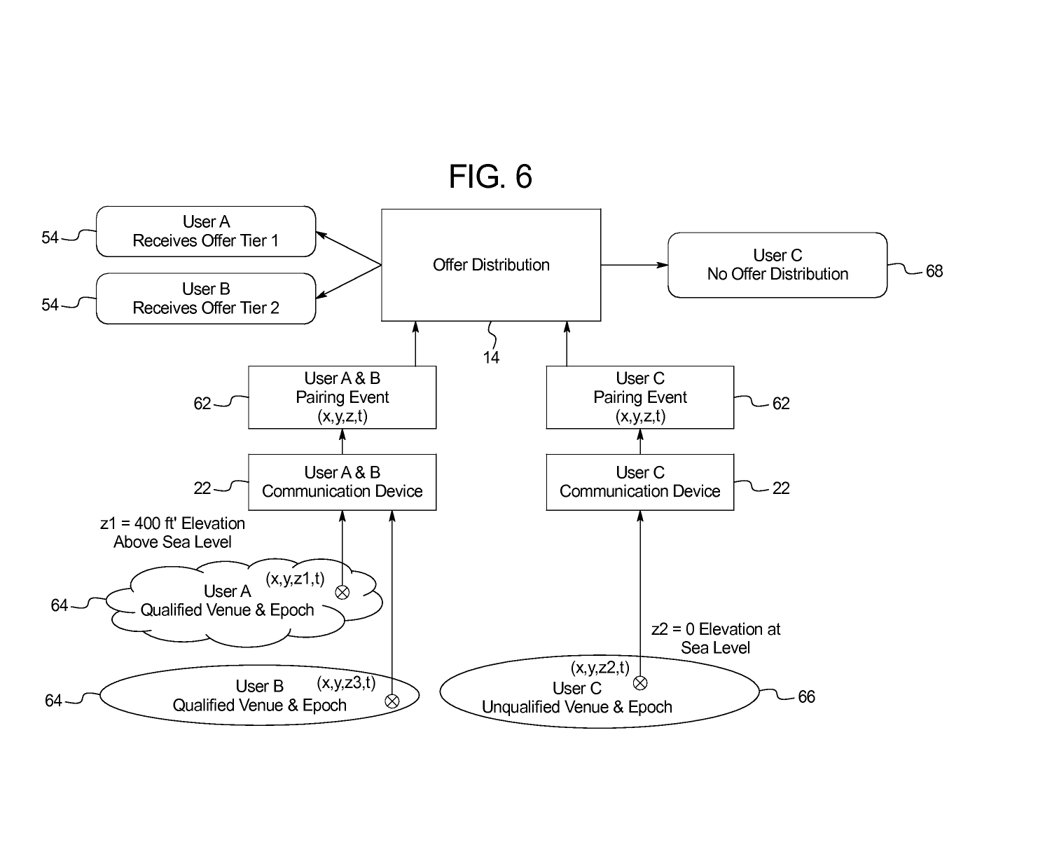

FIG. 6 illustrates an offer distributor 14 as provided within an example of the offer pairing and distribution system 10. In the example shown in FIG. 6, the offer distributor 14 interacts with one or more user pairing events 62, in which one or more qualified venues and epochs 64 and one or more unqualified venues and epochs 66 are evaluated through user devices 22 to provide one or more stratified offers 54 and/or one or more non-offers 68.

FIGS. 5 and 6 together help illustrate how the offer pairing and distribution system 10 may be adapted to qualify offers based on multi-dimensional venues (i.e., including any combination of latitude, longitude, elevation, and time components). In one example, the offer pairing and distribution system 10 may be used to create a three-dimensional or four-dimensional venue for dynamic offer distribution to a user device 22. For example, by relying on the mobile GPS or mobile triangulation services of the user device 22.

As shown in FIG. 6, through the user pairing event 62, the offer pairing and distribution system 10 may perform the step of qualified distribution 700. As shown, User A is determined to be a qualified user because User A's user device 22 is located within a qualified venue and epoch 64 at the time User A requests distribution of the offer 54. Similarly, User B is determined to be a qualified user because User B's user device 22 is located within a qualified venue and epoch 64 at the time User B requests distribution of the offer 54. Conversely, because User C's user device 22 is located within an unqualified venue and epoch at the time User C requests distribution of the offer 54, no offer is distributed to User C 68. It is relevant to note than the only difference between the location of User B and User C, is the elevation. This is important in that such elevation distinctions may be used to qualify users located on certain floors of buildings or at certain heights of climbs, etc. Three-dimensional venue definitions may be especially important in qualifying venues on certain floors within high-rise buildings.

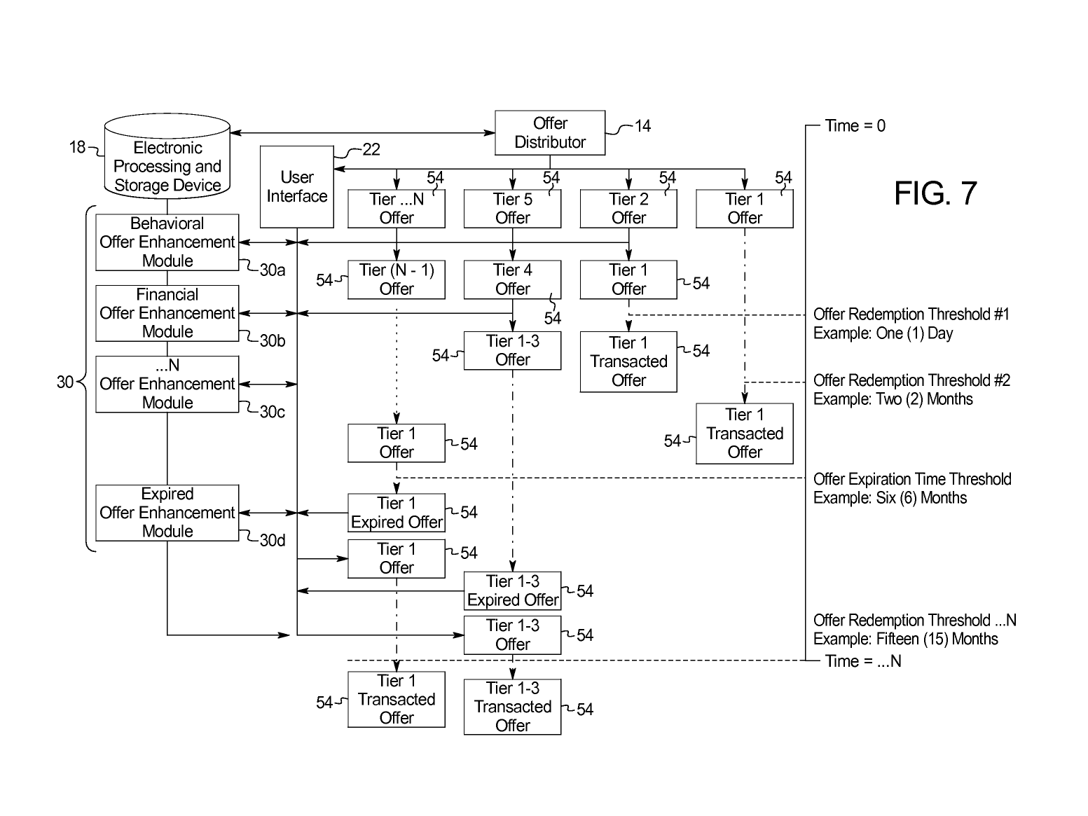

FIG. 7 illustrates an offer enhancement module 30 as provided within an example of the offer pairing and distribution system 10. In the example shown in FIG. 7, the offer enhancement module 30 includes a behavioral offer enhancement module 30a, a financial offer enhancement module 30b, any number of other offer enhancement modules 30c, and an expired offer enhancement module 30d. As further shown in FIG. 7, the enhancement module 30 interacts with an offer distributor 14 and a user device 22 to provide any of a number of stratified offers 54.

FIG. 7 illustrates how an offer distributor 14 may create a complexly tiered offer structure and distribute the tiered offers 54 to user interfaces 22 with input from the enhancement module 30. The system 10 shown in FIG. 7 is vastly different from traditional unmonitored offer systems. In the example shown, when attributes of an offer (such as expiration or value) are, or become, unfavorable to user, then offer distributor 14 assigns enhancements to the offer (i.e., selects a tiered offer 54 from another tier) to make the offer more favorable to user. As shown, the various components of the enhancement module 30 may monitor and evaluate the behavioral, financial, and expiration conditions of the tiered offers 54, to continuously monitor and update the tiered offers 54 provided to the user device 22 to create optimum demand for and utilization of the tiered offers 54.

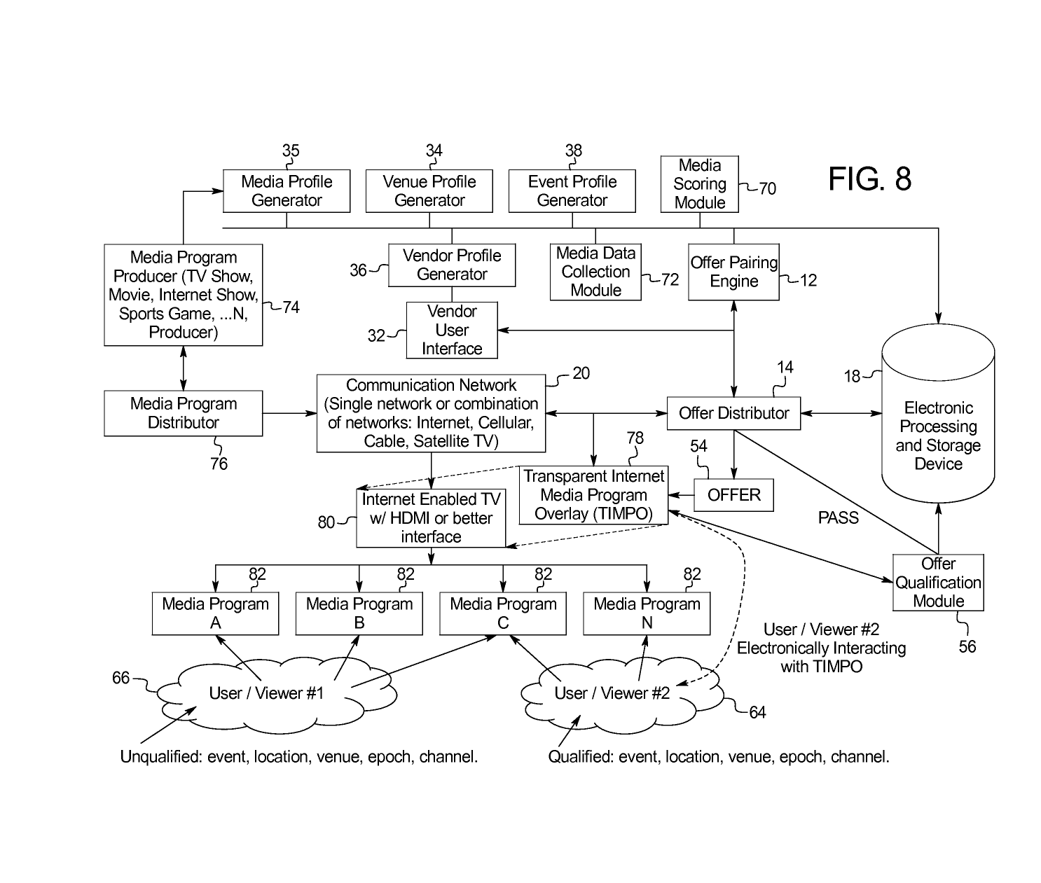

FIG. 8 illustrates an example of a programmed media offer pairing system 69 through which there is dynamic pairing and distribution of offers through a television, Internet, cable television, or satellite television media programs and a user device 22. As shown in FIG. 8, the system 69 inventories, profiles, and maps screen location of media program elements, for example through a transparent Internet (or application based) media program overlay 78 (TIMPO 78). Media program elements include: props, clothing, locations, brands, products, furniture, animals, food or other items included within the media program 82. The system 69 communicates with vendors of said media program elements or competing vendors of same products in order to procure offers to be made to the viewers of media program 82. The system 69 may profile media prior, during, or after media program 82 is distributed. The system 69 may pair the media profile with vendors and offers during original distribution or re-run distribution of a media program 82. The system 69 may or may not qualify viewers to receive offers based on any of the following or any combination of the following: user/viewer location pairing; media program being viewed; sensational moments within the media program 82 when viewer is prompted to be paired; paired by user selecting element of program highlighted by the TIMPO 78. The system 69 displays selected products to viewers by employing the TIMPO 78, which is placed over the media program 82. The TIMPO 78 serves as a user/viewer interface, thus allowing the user to select or deselect portions of the TIMPO 78. The TIMPO 78 is electronically interfaced with an offer qualification module 56, offer distributor 14, and an electronic processing and storage device 18. The purpose of the system 69 is to enable users or viewers of programmed media 82 to interact, select, interface, and pair with the programmed media 82 in order to receive information or offers related to the programmed media 82.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. An offer pairing and distribution system comprising:
an electronic processing and storage device associated with an offer pairing engine and an offer distributor, wherein the offer pairing engine receives input profiling events, vendors, venues, and distributors to create one or more offers to be distributed via the offer distributor to one or more qualified users who request distribution of the one or more offers when located within a defined location and epoch.

2. A method of pairing and distributing offers includes the steps of:
generating profiles for events, venues, vendors, and distributors;
pairing a combination of events, venues, vendors, and distributors to create an offer using the profiles generated for events, venues, vendors, and distributors;
exploiting an offer wherein one or more paired offers are publicized to qualified and unqualified prospects;
qualified distribution of the paired offers to qualified prospects;
receiving an acceptance of an offer by a qualified prospect;
enhancing the offer, which may include the additional steps of offer expiration and post-expiration offer enhancement, whereby the accepted offers may be enhanced by adapting the value or duration of the offer;
receiving a request to redeem an offer, wherein a qualified prospect redeems the offer; and
rewarding a qualified prospect for participation.

3. The method of claim 2 further including the steps of media data collection and media scoring to generate a media score that is used to assign a value to the events, venues, vendors, and distributors for which media data is collected.
